(19) United States
(12) Patent Application Publication
(10) Pub. No.: US 2025/0117236 A1
(43) Pub. Date: Apr. 10, 2025

(54) SITE RELIABILITY ENGINEERING AS A SERVICE (SREAAS) FOR SOFTWARE PRODUCTS

(71) Applicant: VMware, Inc., Palo Alto, CA (US)

(72) Inventors: Ziyou WANG, Beijing (CN); Donghai HAN, Beijing (CN)

(73) Assignee: VMware, Inc., Palo Alto, CA (US)

(21) Appl. No.: 18/377,824

(22) Filed: Oct. 8, 2023

(51) Int. Cl. G06F 9/455

(52) U.S. Cl. CPC G06F 9/45558; G06F 2009/45591; G06F 2009/45595

(57) ABSTRACT

Site reliability engineering (SRE) may be provided as a service to software products, such as an on-premises software product residing at a first computing environment. A SRE service site may be hosted at a second computing environment that is remote and separate from the first computing environment. A SRE agent resides at the first computing environment to monitor the software product, and provides information, such as metric data or log information pertaining to the software product, to the SRE service site. A SRE service of the SRE service site performs analysis of the information to identify an issue with the software product, diagnosis to determine a cause of the issue, and identifies a remediation that may be applied by the SRE agent to address the issue.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC) or other type of virtualized computing environment. For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

To provide reliable operation of such operating systems, applications, and other software products in a virtualized computing environment or other type of computing environment, maintenance-related tasks directed towards these software products (including as examples: installing, updating and upgrading, troubleshooting/debugging or other diagnostics, remediation of issues, etc.) should be performed. However, it can be challenging to efficiently and effectively perform such tasks.

### BRIEF DESCRIPTION OF DRAWINGS

FIG. 1A is a schematic diagram illustrating an example architecture having capability to provide site reliability engineering as a service (SREAAS) for software products;

FIG. 1B is a schematic diagram illustrating an example virtualized computing environment in the architecture of FIG. 1A;

FIG. 2 is a schematic diagram illustrating details of a SRE service provided by the architecture of FIG. 1A;

FIG. 3 illustrates an example of a first workflow for providing the SRE service;

FIG. 4 illustrates an example of a second workflow for providing the SRE service; and

FIG. 5 is a flowchart of an example method to provide SRE as a service for software products residing in a first computing environment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be implemented in connection with other embodiments whether or not explicitly described.

The present disclosure is directed towards providing site reliability engineering as a service (SREAAS) for software products, for example providing SREAAS for on-premises software or other types of software products. The embodiments disclosed herein address drawbacks associated with traditional techniques for performing diagnostics, updating/upgrading, remediation, and other maintenance-related tasks for software products, since such techniques are often inefficient or ineffective in addressing issues, and problematic issues can overwhelm on-site maintenance staff.

Generally speaking, site reliability engineering (SRE) uses software engineering to automate tasks such as remediating issues, responding to incidents, monitoring (e.g., for latency, traffic status, errors, etc.), and so forth, for software systems. Historically, SRE is performed on-premises (e.g., on-site where software products reside). According to various embodiments described herein, SRE may be remotely provided from a computing environment, as a service (AAS) for software products residing in another computing environment. Such on-premises software products may include applications, operating systems, hypervisors, virtualization software, distributed storage system software, modules, agents, or other types of software/programs and sub-components thereof.

From a software product user's perspective, the user may subscribe to the SREAAS (referred to at times herein as a/the SRE service) and register the instances of at least one software product at the premises. An SRE agent may be installed in the software products or elsewhere on the premises.

Afterwards, the SRE service is able to continually deliver new/updated features for the SRE agent, even if the software product itself being serviced by the SRE service cannot be upgraded for some reason. For example, if there is a new problem in the software product after the software product has been released and installed, the SRE service can provide (via the updated SRE agent) proper ways to detect, alert, and remediate the problem when or before users encounter the problem.

Further examples and details of various embodiments are provided next below.

### Computing Environment(s) for Providing SRE as a Service

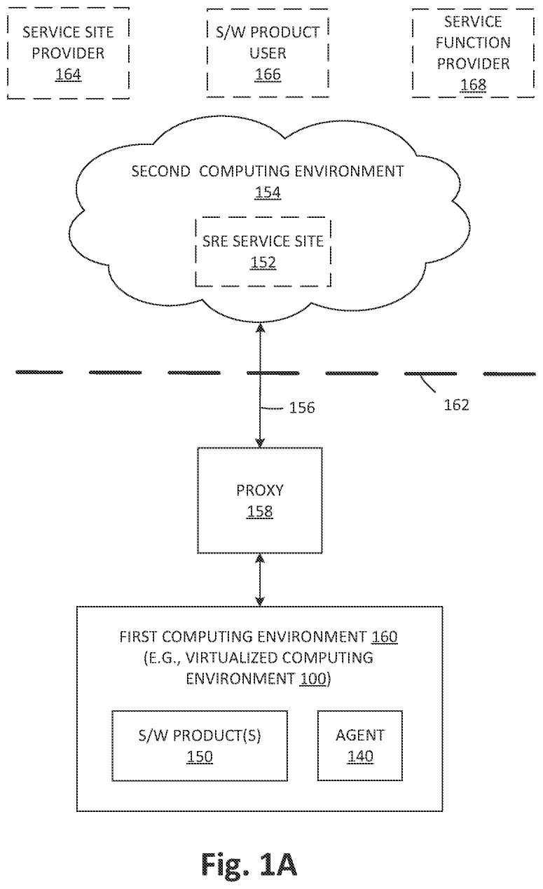

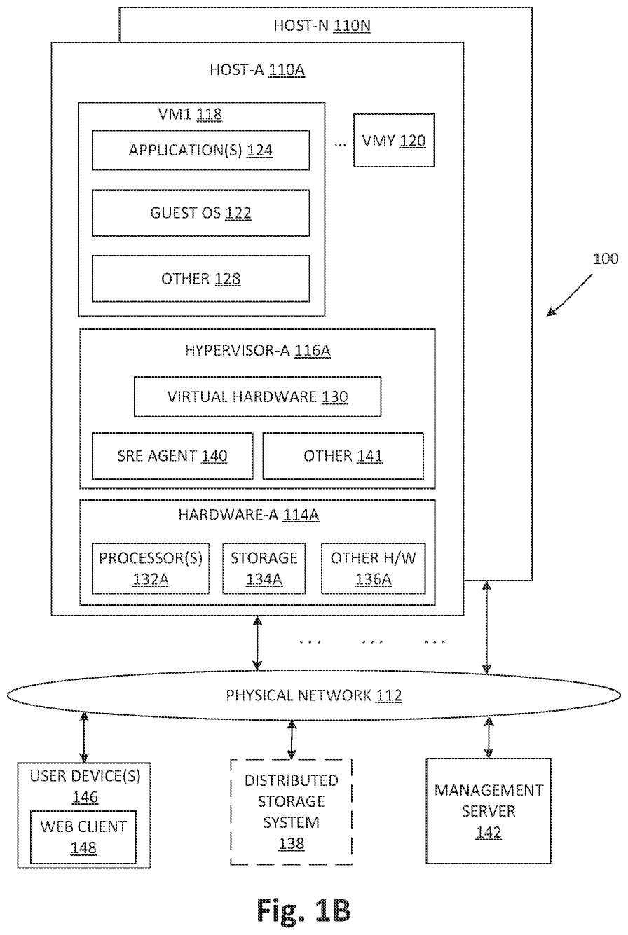

FIG. 1A is a schematic diagram illustrating an example architecture having capability to provide site reliability engineering as a service (SREAAS) for software products. The example architecture of FIG. 1 depicts a first computing environment 160 (such as a virtualized computing environment 100) where one or more software products 150 may reside. For example, the software products 150 may reside as individual instances in devices (such as in hosts) that provide the infrastructure for the virtualized computing environment 100. It is also possible for sub-components of the software products 150 to be distributed across multiple devices in the virtualized computing environment 100 (e.g., as distributed applications or other types of software).

In other embodiments, the first computing environment 160 need not necessarily include virtualized components or other aspects of a virtualized computing environment. For example, such a first computing environment 160 may include one or more physical devices and sub-components thereof that are not used for virtualization, and the software products 150 may reside on such devices.

The software products 150 of various embodiments may be on-premises software products or other types of software products that are not necessarily on-premises software products. For example, the first computing environment 160 may be a local area network (LAN) of an entity and is residing at a geographical location/premises of the entity, and so the software products 150 residing in the first computing environment 160 may be on-premises software products. As another example, if the first computing environment 160 includes the virtualized computing environment 100, the software products 150 may be on-premises software products in that such software products reside wherever the physical devices of the virtualized computing environment 100 are residing and are maintained by a provider of the virtualized computing environment 100.

Whether the software products 150 are considered as on-premises software products or not-on-premises software products may vary from one implementation or interpretation to another. In general throughout the present disclosure, the embodiments are directed towards providing a SRE service to software products 150 in the first computing environment 160 that is remotely located from a second computing environment 154 that is the source/provider of the SRE service, regardless of the classification of the software products 150 as being on-premises software products or not-on-premises software products.

With reference now to the second computing environment 154, the second computing environment 154 may be remote from the first computing environment 160. The second computing environment 154 and the first computing environment 160 may communicate with each other via one or more communication links 156, which may include wired and/or wireless connections. In some embodiments, a proxy 158 may be provided for communication between the second computing environment 154 and the first computing environment 160.

In some embodiments, the second computing environment 154 may be a cloud or other arrangement of one or more computing devices that are separate and external to the first computing environment 160. The second computing environment 154 being external to the first computing environment 160 is symbolically represented in FIG. 1A by a broken line 162 that separates the second computing environment 154 from the first computing environment 160.

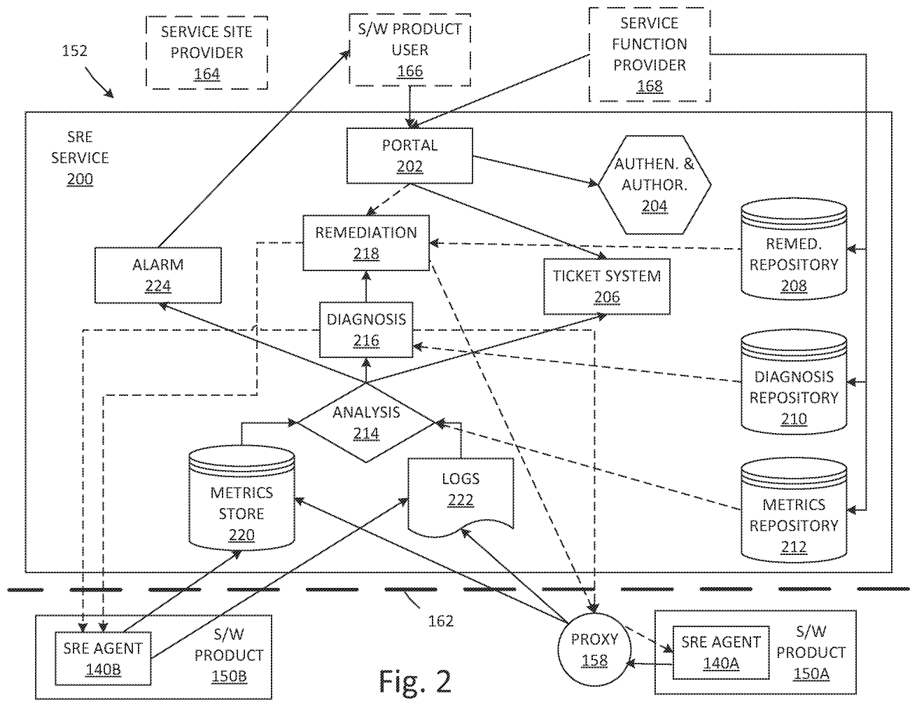

The second computing environment 154 may include one or more servers or other computing device(s) that support the components, functionality, etc. of an SRE service site 152 that provides an SRE service. The various components, functionality, and other features of the SRE service provided by the SRE service site 152 will be described in further detail later below with respect to FIG. 2.

One or more entities may be involved with the operation and other tasks performed for the architecture of FIG. 1. Such entities may include: a service site provider 164, a software product user 166, and a service function provider 168.

According to various embodiments, the service site provider 164 is an entity that is responsible for maintaining the infrastructure of the SRE service site 152 and related functionality in connection with providing SRE services for various software products 150 and their instances. The service site provider 164 of some embodiments may be configured to also maintain the functionality (e.g., core functions) of one or more SRE agents 140 (described later below) that reside at the first computing environment 160 and which monitor the software products 150. For example, the service site provider 164 may perform tasks such as updating the SRE agents 140, managing the life cycles of the SRE agents, providing interfaces (e.g., portals, application program interfaces (APIs), etc.) to access the SRE agents 140 and the SRE service site 152, and other tasks.

In some embodiments, the service site provider 164 (via the SRE service site 152) may be able to directly perform some tasks related to maintaining the software products 150, such as manipulating instances of software products 150 registered to the SRE service site 152, performing monitoring/diagnostics/remediation, and other tasks, alternatively or in addition to such tasks being performed by the service function provider 168. In other embodiments, the site service provider 164 provides the core functionality of the SRE agent 140 and/or of the SRE services provided via the SRE service site 152, and also provides the interfaces to such core functionality, so that the service function providers 168 can access (via the interfaces) and leverage such functionality to implement specific SRE functions for their software products 150.

The service function provider 168 of various embodiments can be one or more entities that have knowledge regarding the software products 150. For example, the service function provider 168 can be a manufacturer of the software product 150, a vendor of the software product 150, a third-party entity/company/service, or other entity that supports or otherwise provides the software product 150. In some embodiments, the service function provider 168 and the service site provider 164 can be the same entity or affiliated entities.

The service function provider 168 of various embodiments may be responsible to continually deliver extensions, updates, etc. to either or both the SRE service site 152 and the SRE agent 140, so as provide more useful, accurate, updated, etc. SRE functions. The service function provider 168 may also have access to all software product instances that originate from or is otherwise associated with the service function provider 168.

When a software product instance encounters problems, the SRE service (e.g., hosted at the SRE service site 152) may automatically trigger the diagnosis and remediation functionality/programs provided by the service function provider 168 to the SRE service site 152. In some situations, it may be possible for the service function provider 168 to also directly access the SRE service site 152 to remotely perform diagnosis and remediation. The service function provider 168 can provide both automatic SRE services and manual SRE services for its customers, via the SRE service site 152 and/or via some other approach.

As an example, the service function provider 168 can leverage the SRE service site 152 to manually triage (e.g., diagnose) an issue with a software product 150 when the issue appears for the first time. Then, the knowledge derived from performing this task and the expertise of the service function provider 168 can be translated into executable programs. The executable programs can be added into the repositories of the SRE service site 152 for use by the SRE service when similar issues are encountered in the future. For instance, for other users who are using the same software product 150, the SRE service site 152 may can automatically use the executable program(s) to select the correct steps to do perform diagnosis and remediation when the same issue happens again in the future.

The software product user 166 of various embodiments may be an end user, system administrator, or other entity that is able to view the instances of the software products 150 that the software product user 166 owns/controls. Although the software product user 166 can view a dashboard of the user's software products 150, the software product user 166 may have just limited rights to change a state of the software product 150. For example, limited rights may be granted/available because the software product user 166 may have insufficient SRE expertise pertaining to the software product 150.

According to various embodiments, software product users 166 may submit SRE tickets to the SRE service site 152 when they discover some abnormal state or other issue with their software products 150. In some embodiments, the service function provider 168 (such as product vendors) may discover new issues based on reports/tickets from the software product user 166 and/or may independently discover such issues by investigating metrics and logs collected by the SRE agent 140. In some embodiments, potential issues and/or investigations thereof may be indicated or triggered by predefined thresholds on some metrics being met.

According to various embodiments, the service site provider 164 and the service function provider 168 implement the SRE agent 140 which can be integrated with different software products. Furthermore, since the SRE features provided by the SRE service site 152 may need to be and should be upgraded according to software product release cycles, the SRE agent 140 may be upgraded on-demand. Since the SRE service provided by the SRE service site 152 may iterate with updates much faster than on-premises software products (e.g., the software products 150), the SRE agent 140 may be provided with an extendable architecture that can install/uninstall/upgrade SRE functionality at runtime. In some embodiments, software product users 166 do not need to modify the state of the SRE agent 140 (e.g., may not have access rights to perform such modification), since the service site provider 164 and/or the service function provider 168 controls the configuration of the SRE agent 140.

In the embodiment of FIG. 1A, the SRE service is hosted on a separate site (e.g., the SRE service site 152 that is separate and remote from the first computing environment 160) and provides various SRE functions, such as metrics visualization, alarm, diagnosis and remediation, etc. for multiple instances of the software products 150 utilized by the software product users 166. A function/feature that is supported in some embodiments is to enable service function providers 168 to enhance the SRE functions that may be provided/applied to the software products 150. For other “as a service” (aaS) solutions, the services usually are fully owned by providers and can be upgraded and iterated quickly to enhance their functions. Such may be a challenge for SRE implementations because the software product 150 itself may not be owned by the site service provider 164 and may be unable to be upgraded easily. However, by exporting SRE interfaces to specific service function providers 168 through the SRE agents 140 in various embodiments, such challenges brought about by the on-premises software products 150 are overcome.

FIG. 1B is a schematic diagram illustrating an example of the virtualized computing environment 100 in the architecture of FIG. 1A that can provide SRE services. More specifically, FIG. 1B shows details of the virtualized computing environment 100 (e.g., the first computing environment 160) having software products 150 residing therein that may utilize SRE services provided by the second computing environment 154. Depending on the desired implementation, the virtualized computing environment 100 may include additional and/or alternative components than that shown in FIG. 1B. The virtualized computing environment 100 may comprise parts of a data center, distributed storage system architecture, software-defined network (SDN), some other type of private internal network (e.g., a customer/user environment), etc.

In the example in FIG. 1B, the virtualized computing environment 100 includes multiple hosts, such as host-A 110A . . . host-N 110N that may be inter-connected via a physical network 112, such as represented in FIG. 1B by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of host-A 110A. Each of the other hosts can include substantially similar elements and features.

The host-A 110A includes suitable hardware-A 114A and virtualization software (e.g., hypervisor-A 116A) to support various virtual machines (VMs). For example, the host-A 110A supports VM1 118 . . . VMY 120, wherein Y (as well as N) is an integer greater than or equal to 1. In practice, the virtualized computing environment 100 may include any number of hosts (also known as “computing devices”, “host computers”, “host devices”, “physical servers”, “server systems”, “physical machines,” etc.), wherein each host may be supporting tens or hundreds of virtual machines. For the sake of simplicity, the details of only the single VM1 118 are shown and described herein.

VM1 118 may include a guest operating system (OS) 122 and one or more guest applications 124 (and their corresponding processes) that run on top of the guest operating system 122. VM1 118 may include still further other elements 128, such as a virtual disk, agents, engines, modules, and/or other elements usable in connection with operating VM1 118. The OS 122, guest applications 124, hypervisor-A 116-A, or various other components in FIG. 1B that may be implemented in software or other types of code are examples of the software products 150 of FIG. 1A that may utilize the SRE services described herein.

The hypervisor-A 116A may be a software layer or component that supports the execution of multiple virtualized computing instances. The hypervisor-A 116A may run on top of a host operating system (not shown) of the host-A 110A or may run directly on hardware-A 114A. The hypervisor-A 116A maintains a mapping between underlying hardware-A 114A and virtual resources (depicted as virtual hardware 130) allocated to VM1 118 and the other VMs. The hypervisor-A 116A of some implementations may include/run one or more of the SRE agents 140, which may collect data (e.g., metrics) and perform other SRE-related operations as will be described later below. In some implementations, the agent 140 may reside elsewhere in the host-A 110A (e.g., outside of the hypervisor-A 116A), such as in a VM, within an application 124, within an OS, etc. For the sake of illustration, the agent 140 is shown as residing in (e.g., is a part of) the hypervisor-A 116-A in FIG. 1B.

The hypervisor-A 116A may include or may operate in cooperation with still further other elements 141 residing at the host-A 110A. Such other elements 141 may include drivers, other agent(s), daemons, engines, virtual switches, and other types of modules/units/components that operate to support the functions of the host-A 110A and its VMs, including functions associated with using storage resources of the host-A 110A for distributed storage.

Hardware-A 114A includes suitable physical components, such as CPU(s) or processor(s) 132A; storage resources(s) 134A; and other hardware 136A such as memory (e.g., random access memory used by the processors 132A), physical network interface controllers (NICs) to provide network connection, storage controller(s) to access the storage resources(s) 134A, etc. Virtual resources (e.g., the virtual hardware 130) are allocated to each virtual machine to support a guest operating system (OS) and application(s) in the virtual machine, such as the guest OS 122 and the applications 124 in VM1 118. Corresponding to the hardware-A 114A, the virtual hardware 130 may include a virtual CPU, a virtual memory, a virtual disk, a virtual network interface controller (VNIC), etc.

Storage resource(s) 134A may be any suitable physical storage device that is locally housed in or directly attached to host-A 110A, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, integrated drive electronics (IDE) disks, universal serial bus (USB) storage, etc. The corresponding storage controller may be any suitable controller, such as redundant array of independent disks (RAID) controller (e.g., RAID 1 configuration), etc.

A distributed storage system 138 may be connected to each of the host-A 110A . . . host-N 110N that belong to the same cluster of hosts. For example, the physical network 112 may support physical and logical/virtual connections between the host-A 110A . . . host-N 110N, such that their respective local storage resources (such as the storage resource(s) 134A of the host-A 110A and the corresponding storage resource(s) of each of the other hosts) can be aggregated together to form a shared pool of storage in the distributed storage system 138 that is accessible to and shared by each of the host-A 110A . . . host-N 110N, and such that virtual machines supported by these hosts may access the pool of storage to store data. In this manner, the distributed storage system 138 is shown in broken lines in FIG. 1B, so as to symbolically convey that the distributed storage system 138 is formed as a virtual/logical arrangement of the physical storage devices (e.g., the storage resource(s) 134A of host-A 110A) located in the host-A 110A . . . host-N 110N. However, in addition to these storage resources, the distributed storage system 138 may also include stand-alone storage devices that may not necessarily be a part of or located in any particular host.

According to some implementations, two or more hosts may form a cluster of hosts that aggregate their respective storage resources to form the distributed storage system 138. The aggregated storage resources in the distributed storage system 138 may in turn be arranged as a plurality of virtual storage nodes. Other ways of clustering/arranging hosts and/or virtual storage nodes are possible in other implementations.

The management server 142 (or other network device configured as a management entity) of one embodiment can take the form of a physical computer or with functionality to manage or otherwise control the operation of host-A 110A . . . host-N 110N, including operations associated with the distributed storage system 138. In some embodiments, the functionality of the management server 142 can be implemented in a virtual appliance, for example in the form of a single-purpose VM that may be run on one of the hosts in a cluster or on a host that is not in the cluster of hosts. The management server 142 may be operable to collect usage data associated with the hosts and VMs, to configure and provision VMs, to activate or shut down VMs, to monitor health conditions and diagnose/troubleshoot and remedy operational issues that pertain to health, and to perform other managerial tasks associated with the operation and use of the various elements in the virtualized computing environment 100 (including managing the operation of and accesses to the distributed storage system 152).

The management server 142 may be a physical computer that provides a management console and other tools that are directly or remotely accessible to a system administrator or other user. The management server 142 may be communicatively coupled to host-A 110A . . . host-N 110N (and hence communicatively coupled to the virtual machines, hypervisors, hardware, distributed storage system 152, etc.) via the physical network 112. In some embodiments, the functionality of the management server 142 may be implemented in any of host-A 110A . . . host-N 110N, instead of being provided as a separate standalone device such as depicted in FIG. 1.

A user (e.g., the software product user 166 of FIG. 1A) may operate a user device 146 to access, via the physical network 112, the functionality of VM1 118 . . . VMY 120 (including operating the applications 124), using a web client 148. The user device 146 can be in the form of a computer, including desktop computers and portable computers (such as laptops and smart phones). In one embodiment, the user may be an end user or other consumer that uses services/components of VMs (e.g., the application 124) and/or the functionality of the distributed storage system 152. The user may also be a system administrator that uses the web client 148 of the user device 146 to remotely communicate with the management server 142 via a management console for purposes of performing management operations.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

### SRE as a Service

FIG. 2 is a schematic diagram illustrating details of a SRE service 200 provided by the architecture of FIG. 1A. More specifically, FIG. 2 shows various components and functionality of the SRE service 200 that may be provided from the SRE service site 152 maintained by the service site provider 164. The SRE service 200 in the example of FIG. 2 is servicing software products 150A and 150B having respective SRE agents 140A and 140B installed therein or elsewhere.

The SRE agent 140A may communicate indirectly with the SRE service 200 (and vice versa) via the proxy 158, while the SRE agent 140B may communicate directly with the SRE service 200 (and vice versa). In some embodiments, the communication between the SRE service and all SRE agents 140 may be conducted via the proxy 158, while the proxy 158 may be absent in some embodiments (e.g., for direct communication between the SRE service 200 and all SRE agents 140). Some on-premises datacenters may not have or may just have limited network/Internet access. In order to enable the SRE agent 140A to connect to the SRE service site 152, the proxy 158 can be used, or in some embodiments, an on-premises SRE service site version (deployed and maintained by the software product user 166) may be provided.

The software product user 166 and the service function provider 168 may access features and functionality of the SRE service 200 through a portal 202. The portal 202 may provide a login screen, APIs, or other tools to enable this access. The SRE service 200 may include an authorization and authentication unit 204 for security purposes to verify that the software product user 166 and the service function provider 168 have authorized access, including authority to modify states of instances of the software products 150A/150B.

Once provided with access, the software product user 166 may, for example, submit SRE tickets to a ticket system 206 to report problems being encountered with the software products 150A and 150B, alternatively or additionally to such problems being detected and reported by the SRE agents 140A/140B. In some embodiments, the software product user 166 may use its access rights to view/access other functionality, stored information, etc. of the SRE service 200, and may also perform some configuration of the SRE service 200.

The service function provider 168 may use its access rights, for example, to update the features and functionality of the SRE service 200, or to perform other configuration operation. For instance, the service function provider 168 may add/modify/delete features and functionality of the SRE service 200 to correspond to updates (e.g., new versions) of the software products 150A/150B, may use the SRE service 200 to pass updates or other changes (including patches, etc.) to the software products 150A/150B through the respective SRE agents 140A/140B, may use the SRE service 200 to make updates or other changes to the SRE agents 140A/140B, etc.

Some of the information provided by the service function provider 168 to the SRE service 200 may be stored in a plurality of repositories 208-212. The repository 208 may store remediation information; the repository 201 may store diagnostics information; and the repository 212 may store metric information. Such stored information may be used by the SRE service 200 in connection with monitoring for, diagnosing, and remediating issues with the software products 150A/150B. In some embodiments, the stored information may be in the form of scripts or other ordered instruction flow to perform diagnosis, remediation, etc.

The SRE service 200 may further include an analysis unit 214, a diagnosis unit 216, and a remediation unit 218. The SRE service 200 also may further include/maintain a metrics store 220 to receive metrics from the agents 140A/140B that pertain to operation of the software products 150A/150B, and logs 222 that provide a historical record of the performance (including issues) of the software products 150A/150B as reported by the agents 140A/140B. The information in the metrics store 220 and the logs 222 may be used by the analysis unit 214, which when appropriate, may generate an alarm 224 or other notification to the software product user 166.

Even though the SRE agent 140A/140B may only export metric data and log information, some sensitive software product users 166 may have concerns about data security. For these situations, some embodiments of the SRE agent 140A/140B can filter/replace sensitive data/information before sending it to the SRE service site 152, thereby providing improved security.

With further regards to the metrics store 220, the SRE agent 140A/140B exports performance metrics of the software products 150A/150B to the metric store 220 so as to enable the SRE service 200 to perform visualization, analysis, etc. using the analysis unit 214. Some of the metrics may be fixed once the software product 150A/150B is delivered to the software product user 166. However, such (initial) metrics may be insufficient for the SRE service 200 to detect some new problems. Therefore and according to various embodiments, the SRE agent 140A/140B can be upgraded separately with updated metrics that capture more/different metric data, so that the analysis unit 214 can implement corresponding new/updated checking logic. Thus, the service function provider 168 can leverage this feature to provide more and/or revised metric collection functions for released software products.

With further regards to the logs 222, some software products 150 may only export log files in a predefined manner. The SRE agent 140 of some embodiments can provide more choices for the form/content of the log files depending on the SRE service requirements, such as filtering and on-demand collection. For example, some log items may be exported that are related to a known problem when a new software product problem is found.

Based on the metrics contained in the metric store 220 and the logs 222 (and also the metrics repository 212), the analysis unit 214 can analyze the status of the software product 150A/150B and determine abnormal behaviors that deviates from the expected operational behavior of the software product 150. The rules for determining abnormal behavior can be defined by either the service function provider 168 or the software product user 166. For the software product user 166, customized rules may be appropriate to monitor the software product 150A/150B in a particular manner and to perform specific actions. In order to define rules, a domain specific language (DSL) or other tool can be used to define a condition/action, and a rule engine of the SRE service 200 can automatically compile and execute the rules. Structured query language (SQL)-like languages may be used to define customized dashboards that may be provided to the software product user 166 via the portal 202 or other interface between the software product user 166 and the SRE service 200.

When the analysis unit 214 detects an abnormal condition, the analysis unit 214 can trigger the alarm 224, which may be presented on a display of the user device 146 of FIG. 1B. Messaging, email, or other communication method can be used to send the alarm 224 to the software product user 166. The software product user 166 can also customize the alarms 224 and associate the alarms 224 with different conditions/problems that are detected.

When a problem or other type of event is detected by the analysis unit 214, the analysis unit 214 may instruct the ticket system 206 to create a ticket to record the problem/event and to track the follow up status. If the SRE service 200 is able to locate proper scripts from its repositories 208-212 to find a root cause of the problem and to remedy the problem, the software product user 166 and the service function provider 168 may receive a fixed ticket status notification in a ticket list.

If the foregoing fails for some reason (e.g., unable to successfully diagnose and/or remediate), then the ticket may be assigned to the corresponding service function provider 168 for further investigation and closing when the problem is resolved. There also may be some new problems that cannot be detected or remedied automatically, and so the software product user 166 can trigger a ticket for such problems to instruct the service function provider 168 to investigate and remedy the problems.

When the software product 150A/150B or other related component of the system of the software product user 166 enters an abnormal status, the diagnosis unit 216 is configured to investigate the abnormal status and to find a root cause, and then a proper remediation or other suggestion can be selected by the remediation unit 218 for presentation to the software product user 166. For issues such as resource, latency, or overhead, many diagnosis-related operations need not always be turned on. Furthermore, logic for diagnosis may be developed when problems are found after software products 150 are released. Thus, the SRE service 200 of some embodiments, in addition to enhancing/upgrading the SRE agents 140A/140B to support new diagnostic operations, is also configured to trigger the diagnosis unit 216 on demand when problems occur.

According to various embodiments, the service function provider 168 has the expertise regarding the software products 150 and continually delivers new/updated functions for use by the diagnosis unit 216. In enable this capability, the SRE service 200 provides interfaces (such as APIs) for the service function provider 168 to provide their knowledge as executable programs. Such executable programs can include scripts stored in the diagnosis repository 210, and can leverage the interfaces provided by the SRE agent 140A/140B to trigger diagnosis actions on the target software product instances.

When a problem is confirmed after the diagnosis by the diagnosis unit 216, the remediation unit 218 can provide some remediation choices, including remediation scripts or other remediation information from the remediation repository 208. The SRE agent 140A/140B may then trigger the remediation operations and monitor the execution results. Analogous to diagnosing, the remediation expertise may also come from the service function provider 168. The remediation scripts may be relayed by the remediation unit 218 to interfaces of the SRE agents 140A/140B to change the states of the software product 150A/150B or to otherwise apply the remediation.

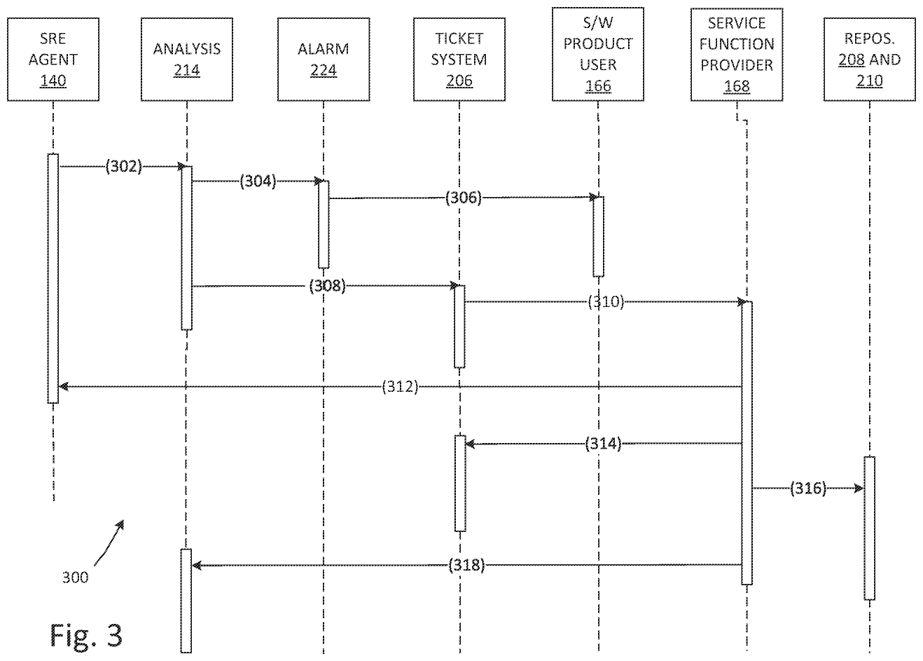

FIG. 3 illustrates an example of a first workflow 300 for providing the SRE service 200. For instance, the workflow 300 may be a process/method implemented in/by the SRE service 200 of FIG. 2 with respect to the software products 150A/150B, when there are new problems (e.g., a first occurrence of a particular issue with the software product 150 for which there has been no historical diagnostic or remediation information for reference). One or more of the software product user 166, the service function provider 168, or the service site provider 164 may be involved with some of the operations in the workflow 300.

The example workflow 300 may include one or more operations, functions, or actions illustrated by one or more operations 302 to 318. The various operations of the workflow 300 and/or of any other workflows described herein may be combined into fewer operations, divided into additional operations, supplemented with further operations, and/or eliminated based upon the desired implementation. In one embodiment, the operations of the workflow 300 and/or of any other workflows described herein may be performed in a pipelined sequential manner. In other embodiments, some operations may be performed out-of-order, in parallel, etc.

The SRE agent 140 sends (at 302) metric data and/or log information to the analysis unit 214. The analysis unit 214 may then analyze the data/information to determine if there are any abnormalities or other issues. If an issue is detected, then the analysis unit 214 triggers (at 304) the alarm 224.

The alarm 224 provides a notification (at 306) to the software product user 166 regarding the issue. Alternatively or additionally to the alarm 224, the analysis unit 214 may create a ticket that is sent (at 308) to the ticket system 206. The ticket system 206 then notifies (at 310) the service function provider 169 of the issue, so that the service function provider 168 can further investigate the issue (e.g., perform diagnostics, determine an appropriate remediation for the issue, etc.).

The service function provider 168 may then send (at 312) diagnostic and remediation information to the SRE agent 140. The SRE agent 140 may in turn perform the remediation to address the issue.

Furthermore, the service function provider 168 may instruct (at 314) the ticket system 206 to close the ticket. Still further, the diagnostic and remediation information provided by the service function provider 168 may be used to respectively update (at 316) the diagnosis repository 210 and the remediation repository 208, for future use when similar issues are encountered. The service function provider 168 may also update (at 318) the logic or other information used by the analysis unit 214) for performing analysis.

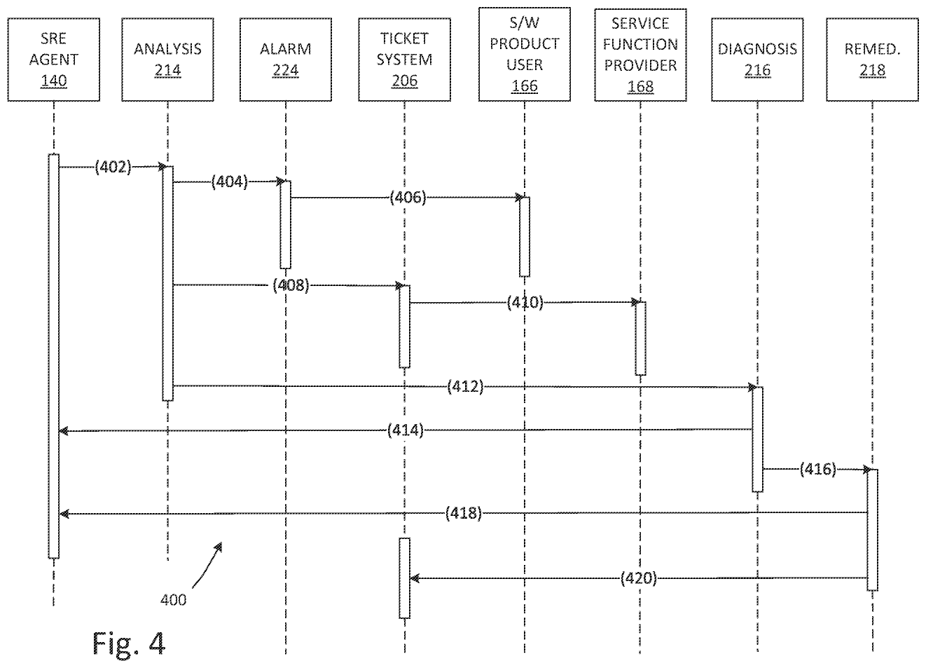

FIG. 4 illustrates an example of a second workflow 400 for providing the SRE service 200. For instance, the workflow 400 may be a process/method implemented in/by the SRE service 200 of FIG. 2 with respect to the software products 150A/150B, when there is existing diagnostic or remediation information for reference. One or more of the software product user 166, the service function provider 168, or the service site provider 164 may be involved with some of the operations in the workflow 400.

The SRE agent 140 sends (at 402) metric data and/or log information to the analysis unit 214. The analysis unit 214 may then analyze the data/information to determine if there are any abnormalities or other issues. If an issue is detected, then the analysis unit 214 triggers (at 404) the alarm 224.

The alarm 224 provides a notification (at 406) to the software product user 166 regarding the issue. Alternatively or additionally to the alarm 224, the analysis unit 214 may create a ticket that is sent (at 408) to the ticket system 206. The ticket system 206 then notifies (at 410) the service function provider 169 of the issue, so that the service function provider 168 can further investigate the issue (e.g., perform diagnostics, determine an appropriate remediation for the issue, etc.).

The analysis unit 214 may further trigger (at 412) the diagnosis unit 216 to diagnose (e.g., the determine a cause of) the issue. To perform this diagnosis, the diagnosis unit 216 may use one or more of: the information (e.g., diagnostic scripts, etc.) that is stored in the diagnosis repository 210, metric data in the metrics store 220, log information from the logs 222, etc.

The diagnosis unit 216 sends (at 414) the results of the diagnosis (e.g., an identification of the cause of the issue) to the SRE agent 140. The diagnosis unit 216 also notifies (at 416) the remediation unit 218 of the cause of the issue, so as to instruct the remediation unit 218 to identify and trigger a corresponding remediation for the issue. The remediation unit 218 may use scripts or other information in the remediation repository 208 to identify a particular remediation to address the issue.

The remediation unit 218 instructs (at 418) the SRE agent 140 to apply the remediation. The remediation unit 218 may also inform (at 420) the ticket system 206 to update and close the ticket.

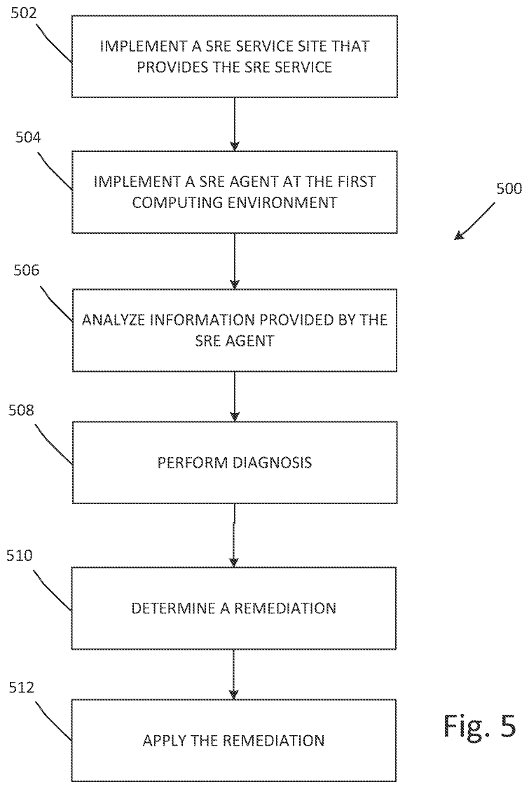

FIG. 5 is a flowchart of an example method 500 to provide SRE as a service for software products 150 residing in the first computing environment 160. Components of the SRE service 200 may perform at least some of the operations in the method 500 in some embodiments, in combination with the SRE agent 140.

The method 500 may begin at a block 502 (“IMPLEMENT A SRE SERVICE SITE THAT PROVIDES THE SRE SERVICE”), wherein the SRE service site 152 is implemented (e.g., hosted) at the second computing environment 154 that is remote from (and external to) the first computing environment 160. The SRE service site 152 may provide the SRE service 200, including its components such as shown in FIG. 2 and the related functionality. The block 502 may be followed by a block 504.

At the block 504 (“IMPLEMENT A SRE AGENT AT THE FIRST COMPUTING ENVIRONMENT”), the SRE agent 140 may be implemented at the first computing environment 160, such as being installed in the software product 150 or elsewhere in the first computing environment. The SRE agent 140 is configured to then monitor the software product 150, and to generate metric data, log information, or other information that is provided to the SRE service 200. The block 504 may be followed by a block 506.

At the block 506 (“ANALYZE INFORMATION PROVIDED BY THE SRE AGENT”), the analysis unit 214 analyzes the information provided by the SRE agent 140 to identify an issue pertaining to the software product 150. Such issue can be, for example, a malfunction, a bug, undue latency, etc. The block 506 may be followed by a block 508.

At the block 508 (“PERFORM DIAGNOSIS”), the analysis unit 214 has identified an issue, and the diagnosis unit 216 performs a diagnosis to identify a cause of the issue. The cause of the issue may be a root cause or some other issue that results in the issue with the software product 150 and/or with its related components. To perform the diagnosis, the diagnosis unity 216 may use/run a diagnostic script stored at the diagnosis repository 210. The block 508 may be followed by a block 510.

At the block 510 (“DETERMINE A REMEDIATION”), the remediation unit 218 determines, from the cause of the issue identified by the diagnosis unit 216, a remediation to address the issue. To determine the remediation, the remediation unit 218 may use/run a remediation script stored at the remediation repository 208. The block 510 may be followed by a block 512.

At the block 512 (“APPLY THE REMEDIATION”), the SRE service 200 may instruct the SRE agent 140 to apply the remediation at the first computing environment 160. Applying the remediation may include, for example, restarting the software product 150, upgrading/updating the software product 150, uninstalling and replacing the software product 150, making some other modification to the software product 150, etc.

### Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1A to 5.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term “processor” is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system. Moreover, some embodiments may be implemented in other types of computing environments (which may not necessarily involve a virtualized computing environment and/or a distributed storage system), wherein it would be beneficial to provide SRE as a service.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other computer-readable instruction to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

1. A method to provide site reliability engineering (SRE) as a service for software products residing in a first computing environment, the method comprising:
implementing a SRE service site, which provides the SRE service, at a second computing environment remote from the first computing environment;
implementing a SRE agent at the first computing environment, wherein the SRE agent is configured to obtain information regarding a software product in the first computing environment and to provide the obtained information to the SRE service site;
analyzing, at the SRE service site, the information provided by the SRE agent to identify an issue pertaining to the software product;
performing diagnosis, at the SRE service site, to identify a cause of the issue;
determining, at the SRE service site and from the cause of the issue, a remediation to address the issue; and
instructing the SRE agent to apply the remediation at the first computing environment.

2. The method of claim 1, wherein the first computing environment includes a virtualized computing environment where the software product resides.

3. The method of claim 1, wherein performing the diagnosis and determining the remediation respectively comprise:
using a diagnostic script stored at a diagnosis repository at the SRE service site to identify the cause of the issue; and
using a remediation script stored at a remediation repository at the SRE service site to determine the remediation to address the issue.

4. The method of claim 1, further comprising updating the SRE agent in response to a change in the software product.

5. The method of claim 1, further comprising after having analyzed the information and identified the issue:
triggering the performing the diagnosis to identify the cause of the issue;
generating an alarm to notify a first entity, being a user of the software product, of the issue; and
generating a ticket to inform a second entity, being a provider of the software product, of the issue,
wherein reference information exists at the SRE service site that is applicable to the issue.

6. The method of claim 1, further comprising after having analyzed the information and identified the issue:
generating an alarm to notify a first entity, being a user of the software product, of the issue; and
generating a ticket to inform a second entity, being a provider of the software product, of the issue,
wherein the issue is a new issue at the first computing environment for which reference information applicable to the issue is absent from the SRE service site.

7. The method of claim 1, wherein:
a first entity is a user of the software product,
a second entity is a provider of the software product,
a third entity maintains the SRE service site and the SRE agent, and
the third entity provides at least one interface to the SRE service and to the SRE agent to enable the second entity to update functionality of the SRE service and the SRE agent.

8. The method of claim 7, further comprising maintaining, at the SRE service site, at least one or more of:
a first repository to store reference metric information;
a second repository to store reference diagnosis information;
a third repository to store reference remediation information,
wherein the second entity provides and updates the reference metric information, the reference diagnosis information, and the reference remediation information.

9. A non-transitory computer-readable medium having instructions stored thereon, which in response to execution by one or more processors, cause the one or more processors to perform or control performance of a method to provide site reliability engineering (SRE) as a service for a software product residing in a first computing environment, wherein the method comprises:
receiving, at a SRE service site hosted at a second computing environment remote from the first computing environment, information from a SRE agent residing at the first computing environment, wherein the information is collected by the SRE agent and pertains to operational behavior of the software product;
analyzing, at the SRE service site, the information received from the SRE agent to identify an issue pertaining to the software product;
performing diagnosis, at the SRE service site, to identify a cause of the issue;
determining, at the SRE service site and from the cause of the issue, a remediation to address the issue; and
instructing the SRE agent to apply the remediation at the first computing environment.

10. The non-transitory computer-readable medium of claim 9, wherein performing the diagnosis and determining the remediation respectively comprise:
using a diagnostic script stored at a diagnosis repository at the SRE service site to identify the cause of the issue; and
using a remediation script stored at a remediation repository at the SRE service site to determine the remediation to address the issue.

11. The non-transitory computer-readable medium of claim 9, wherein the method further comprises updating the SRE agent in response to a change in the software product.

12. The non-transitory computer-readable medium of claim 9, wherein the method further comprises after having analyzed the information and identified the issue:
triggering the performing the diagnosis to identify the cause of the issue;
generating an alarm to notify a first entity, being a user of the software product, of the issue; and
generating a ticket to inform a second entity, being a provider of the software product, of the issue,
wherein reference information exists at the SRE service site that is applicable to the issue.

13. The non-transitory computer-readable medium of claim 9, further comprising after having analyzed the information and identified the issue:
generating an alarm to notify a first entity, being a user of the software product, of the issue; and
generating a ticket to inform a second entity, being a provider of the software product, of the issue,
wherein the issue is a new issue at the first computing environment for which reference information applicable to the issue is absent from the SRE service site.

14. The non-transitory computer-readable medium of claim 9, wherein the method further comprises providing an interface to the SRE service site to enable an entity, which provides the software product, to update functionality of the SRE service site or the SRE agent.

15. A system to provide site reliability engineering (SRE) as a service for a software product residing at a remote computing environment, the system comprising:
one or more processors; and
a non-transitory computer-readable medium coupled to the one or more processors and having instructions stored thereon which, in response to execution by the one or more processors, cause the one or more processors to perform operations to:
receive, from a SRE agent residing at the remote computing environment, information collected by the SRE agent and that pertains to operational behavior of the software product;
operate an analysis unit to identify, from the information received from the SRE agent, an issue pertaining to the software product;
operate a diagnosis unit to identify a cause of the issue; and
operate a remediation unit to determine, from the cause of the issue, a remediation to address the issue, wherein the remediation unit is configured to instruct the SRE agent to apply the remediation at the remote computing environment.

16. The system of claim 15, wherein the instructions, in response to execution by the one or more processors, further cause the one or more processors to perform operations to:
provide an interface to enable an entity to update functionality of the SRE agent, wherein the entity is a provider of the software product, and wherein the functionality of the SRE agent is updated in response to a change in the software product.

17. The system of claim 15, wherein the instructions, in response to execution by the one or more processors, further cause the one or more processors to perform operations to:
generate an alarm to notify a first entity, being a user of the software product, of the issue; and
generate a ticket to notify a second entity, being a provider of the software product, to investigate the issue to determine the cause of the issue and the remediation to address the issue.

18. The system of claim 15, wherein the remote computing environment includes a virtualized computing environment where the SRE agent resides, and wherein the analysis, diagnosis, and remediation units reside in a cloud computing environment.

19. The system of claim 15, further comprising:
a first repository to store reference metric information usable by the analysis unit to identify the issue;
a second repository to store reference diagnosis information usable by the diagnosis unit to identify the cause of the issue;
a third repository to store reference remediation information usable by the remediation unit to determine the remediation.

20. The system of claim 15, wherein the information received from the SRE agent is received from a proxy.
